(19) United States
(12) Patent Application Publication
(10) Pub. No.: US 2026/0342617 A1
(43) Pub. Date: Oct. 29, 2026

(54) MULTI-SEQUENCE SRS RECEIVER FOR MULTI-TRP OR D-MIMO

(71) Applicant: Telefonaktiebolaget LM Ericsson (publ), Stockholm (SE)

(72) Inventors: Sven JACOBSSON, Västra Frölunda (SE); Andreas NILSSON, Göteborg (SE); Fredrik ATHLEY, Kullavik (SE)

(21) Appl. No.: 19/113,578

(22) PCT Filed: Sep. 29, 2023
(86) PCT No.: PCT/IB2023/059816

§ 371 Date: Mar. 20, 2025

Related U.S. Application Data
(60) Provisional application No. 63/411,690, filed on Sep. 30, 2022.

(51) Int. Cl. H04L 25/02; H04B 7/024; H04J 11/00

(52) U.S. Cl. CPC H04L 25/0204; H04B 7/024; H04J 11/0043; H04J 11/0053; H04L 25/0224

(57) ABSTRACT

Systems and methods for performing channel estimation are provided. In some embodiments, the method includes receiving a combined signal from the two Uplink-Reference Signal (UL-RS) resources at a Transmission and Reception Point (TRP); estimating the channel for the first UL-RS resource at the first TRP from the received combined signal; subtracting the estimated received signal contribution of the first UL-RS resource from the received combined signal from the two UL-RS resources; and estimating the channel for the second UL-RS resource from the received combined signal from the two UL-RS resources subtracted with the estimated received signal contribution of the first UL-RS resource. Some embodiments relate to two UL-RS (e.g., SRS) resources and two TRPs. Some embodiments can be used for more than two SRS resources and/or TRPs. In this way, the quality of reciprocity-based CSI in multi-TRP/D-MIMO deployments for which TRP-specific UL-RS sequences are configured is improved.

### RELATED APPLICATIONS

This application claims the benefit of provisional patent application Ser. No. 63/411,690, filed Sep. 30, 2022, the disclosure of which is hereby incorporated herein by reference in its entirety.

### TECHNICAL FIELD

The present disclosure relates generally to performing channel estimation.

### BACKGROUND

### Sounding Reference Signal (SRS)

In New Radio (NR), SRS is used for providing Channel State Information (CSI) to the NR Node B (gNB) in the Uplink (UL). The usage of SRS includes, e.g., deriving the appropriate transmission/reception beams and/or to perform link adaptation (i.e., setting the transmission rank and the Modulation and Coding Scheme (MCS)), and for selecting Downlink (DL) (e.g., for Physical Downlink Shared Channel (PDSCH) transmissions) and UL (e.g., for Physical Uplink Shared Channel (PUSCH) transmissions) Multiple-Input Multiple-Output (MIMO) precoding.

In Long Term Evolution (LTE) and NR, the SRS is configured via Radio Resource Control (RRC), where parts of the configuration can be updated (for reduced latency) through Medium Access Control-Control Element (MAC-CE) signaling. The configuration includes, for example, the SRS resource allocation (the physical mapping and the sequence to use) as well as the time-domain behavior (aperiodic, semi-persistent, or periodic). For aperiodic SRS transmission, the RRC configuration does not activate an SRS transmission from the UE but instead a dynamic activation trigger is transmitted from the gNB in the DL, via the Downlink Control Information (DCI) in the Physical Downlink Control Channel (PDCCH) which instructs the UE to transmit the SRS once, at a predetermined time.

When configuring SRS transmissions, the gNB configures, through the SRS-Config Information Element (IE), a set of SRS resources and a set of SRS resource sets, where each SRS resource set contains one or more SRS resources.

### SRS Configuration

Each SRS resource is configured in RRC (see Third Generation Partnership Project (3GPP) Technical Specification (TS) 38.331 version 16.1.0).

An SRS resource is configurable with respect to, e.g.,
The number of SRS ports (1, 2, or 4), configured by the RRC parameter nrofSRS-Ports.
The transmission comb (i.e., mapping to every 2nd or 4th subcarrier), configured by the RRC parameter transmissionComb, which includes:
   The comb offset, configured by the RRC parameter combOffset, is specified (i.e., which of the combs that should be used).
   The cyclic shift, configured by the RRC parameter cyclicShift, that configures a (port-specific, for multi-port SRS resources) cyclic shift for the Zadoff-Chu sequence that is used for SRS. The use of cyclic shifts increases the number of SRS resources that can be mapped to a comb (as SRS sequences are designed to be (almost) orthogonal under cyclic shifts), but there is a limit on how many cyclic shifts that can be used (8 for comb 2 and 12 for comb 4).

To provide some context, FIG. 1 illustrates a schematic description of how an SRS resource could be allocated in time and frequency within a slot if resourceMapping-r16 is not signaled. FIG. 2 illustrates SRS transmission without frequency hopping or repetition (top), with frequency hopping (middle), and with repetition (bottom). FIG. 3 illustrates a periodic SRS resource (with periodicity one) over two adjacent UL slots using both frequency hopping and repetition.

### SRS Capacity

Schemes to improve SRS capacity (i.e., the number of SRS ports that can be multiplexed onto a limited set of time-and-frequency resources) have been adopted in NR, which include using transmission comb 2 or 4 (i.e., sounding only every 2nd or 4th subcarrier within the configured bandwidth), and multiplexing several SRS ports onto the same transmission comb by using different cyclic shifts.

FIG. 4 illustrates how 2 or 4 single-port SRS resources can be multiplexed onto the same configured SRS bandwidth by using transmission comb 2 and 4, respectively. Here, the different SRS resources have been configured with different comb offsets (i.e., RRC-configured with different values of the parameter combOffset). FIG. 4 illustrates multiplexing 2 and 4 single-port SRS resources (with varying comb offset) using transmission comb 2 and 4, respectively. Here, each SRS resource is illustrated by means of a unique shade (e.g., SRS resource 1 is shown in white, SRS resource 2 is shown in a downward slant, and so on).

The SRS base sequences, which are used in NR, are such that they are pairwise orthogonal under cyclic shifts. Utilizing this property, it is possible to multiplex several SRS ports onto the same transmission comb by using different cyclic shifts (and the same base sequence) per SRS port. In NR Rel-16, the maximum number of cyclic shifts is 8 and 12 for transmission comb 2 and 4, respectively. For multi-port SRS resources, the different SRS ports belonging to the same SRS resource will be configured with a port-specific cyclic shift per SRS port. Furthermore, for four-port SRS resources, it is possible to use up to two different transmission combs (with two SRS ports and, hence, two cyclic shifts per comb).

FIG. 5 illustrates, in the discrete-time domain (after computing an Inverse Discrete Fourier Transform (IDFT)), the (amplitude value of the) correlation between a cyclically shifted base sequence and the corresponding non-shifted base sequence. Here, the transmission comb is two (such that the maximum number of cyclic shifts is eight) and the sequence length is 48 (which corresponds to an SRS transmission spanning eight Resource Blocks (RBs)). As shown in the figure, the sequences are orthogonal and, hence, can be separated by means of simple signal processing (e.g., through time-domain windowing). FIG. 5 illustrates correlation between cyclically shifted SRS base sequences with the corresponding non-shifted base sequence. Here, the sequence length is 48 samples, and the maximum number of cyclic shifts (CSs) is eight.

There are, however, drawbacks with increasing the SRS capacity by using a higher transmission comb and/or using larger number of cyclic shifts. In FIG. 6, an example is provided of how the correlation in FIG. 5 is affected when the SRS is transmitted over a frequency-selective channel, i.e., a channel with a non-zero delay spread (in FIG. 6, the delay spread is 15 samples long). FIG. 6 illustrates correlation between cyclically shifted SRS base sequences, which have been transmitted over a frequency-selective channel, with the corresponding non-shifted base sequence. Here, the sequence length is 48 samples, and the maximum number of CSs is eight. The orthogonality between the SRS sequences is lost due to the frequency-selective channel. Further note that increasing the number of (used) cyclic shift results in more interference (compare the upper and lower part of the figure). Assuming perfect synchronization, the maximum channel delay spread for which there is no interference is inversely proportional to the product of the subcarrier spacing, the transmission comb, and number of (occupied, and uniformly separated) CSs.

SRS sequence and time-frequency mapping is discussed in 3GPP TS 38.211 V17.0.0. Specific values for the maximum number of cyclic shifts are found in Table 6.4.1.4.2-1. In case of two SRS ports contained in a SRS resource, the two SRS ports are mapped to the same comb offset but allocated with two different cyclic shifts separated by R. In case of four SRS ports contained in a SRS resource, two possible port-allocation options are supported (unless the transmission comb is 8 (supported since NR Rel-17) for which only the second option is supported). In a first option, the four SRS ports are mapped to the same comb offset but allocated four different cyclic shifts separated by π/2. In a second option, the first two SRS ports are allocated with two different cyclic shifts separated by π on a same set of sub-carriers (with a same first comb offset) and the last two SRS ports are allocated with the same two different cyclic shifts as the first two SRS ports but on a different set of sub-carriers (with a same second comb offset).

The definition of the base sequence r̅_{u,v}(0), . . . , r̅_{u,v}(M_{ZC}−1) depends on the sequence length M_{ZC} and is described in section 5.2.2 of 3GPP TS 38.211 V17.0.0.

In NR, the sequence group u is given by:

$$u = ( {f}_{gh} ( {n}_{sf}^{μ} , {l}^{′} ) + {n}_{ID}^{SRS} ) mod 30$$

where

$${n}_{ID}^{SRS} ∈ \{ 0 , 1 , … , 1023 \}$$

is configured by higher layers, and

$${n}_{s , f}^{μ}$$

is the slot number in a radio frame.
Joint DL Transmission from Multiple Transmission and Reception Points (TRPs)

For PDSCH, non-coherent joint transmission (NC-JT) is supported in NR Rel-16. With NC-JT, a subset of the layers of a PDSCH can be transmitted from a first TRP and the rest of layers of the PDSCH can be transmitted from a second TRP. An example is shown in FIG. 7, where layer 1 of a PDSCH is transmitted from TRP1 while layer 2 of the PDSCH is transmitted from TRP2. When multiple antenna ports are deployed at each TRP, a precoding matrix would be applied to the PDSCH at each TRP, e.g., w₁ at TRP1 and w₂ at TRP2. The two TRPs may be in different physical locations.

In NR Rel-18, coherent joint PDSCH transmission (CJT) from multiple TRPs is to be introduced in which a PDSCH layer can be transmitted from up to four TRPs. An example is shown in FIG. 8, where a same PDSCH layer is transmitted over two TRPs. When multiple antenna ports are deployed at each TRP, a precoding matrix would be applied to the PDSCH at each TRP. In addition, a co-phasing factor is also applied so that the PDSCH from the two TRPs are in phase and thus coherently added at the UE. Improved systems and methods for performing channel estimation are needed.

### SUMMARY

Systems and methods for performing channel estimation are provided. In some embodiments, the method includes receiving a combined signal from the two Uplink-Reference Signal (UL-RS) resources at a TRP; estimating the channel for the first UL-RS resource at the first TRP from the received combined signal from the two UL-RS resources; subtracting the estimated received signal contribution of the first UL-RS resource from the received combined signal from the two UL-RS resources; and estimating the channel for the second UL-RS resource from the received combined signal from the two UL-RS resources subtracted with the estimated received signal contribution of the first UL-RS resource.

Note that some embodiments of the present disclosure relate to two UL-RS (e.g., SRS) resources and two TRPs. However, some embodiments of the present disclosure can be used for more than two SRS resources and more than two TRPs.

In this way, the proposed solution improves quality of reciprocity-based CSI in multi-TRP/Distributed-MIMO (D-MIMO) deployments for which TRP-specific UL-RS sequences are configured. In some embodiments, repeating one or more steps for a number of iterations but replacing the received combined signal with the received combined signal subtracted with the estimated received signal contribution of the second UL-RS resource.

In some embodiments, a network node comprises processing circuitry and memory. The memory comprises instructions to cause the network node to: receive combined signal from a first and second UL-RS resources at a first TRP; estimate a received signal contribution of the first UL-RS resource at the first TRP from the received combined signal from the two UL-RS resources; subtract the estimated received signal contribution of the first UL-RS resource from the received combined signal from the two UL-RS resources; and estimate a channel for the second UL-RS resource from the received combined signal from the two UL-RS resources subtracted with the estimated received signal contribution of the first UL-RS resource.

In some embodiments, a computer-readable medium comprises instructions which, when executed on at least one processor, cause the at least one processor to carry out any of the methods disclosed herein.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a schematic description of how an SRS resource could be allocated in time and frequency within a slot if resourceMapping-r16 is not signaled;

FIG. 2 illustrates SRS transmission without frequency hopping or repetition (top), with frequency hopping (middle), and with repetition (bottom);

FIG. 3 illustrates a periodic SRS resource (with periodicity one) over two adjacent UL slots using both frequency hopping and repetition;

FIG. 4 illustrates multiplexing 2 and 4 single-port SRS resources (with varying comb offset) using transmission comb 2 and 4, respectively;

FIG. 5 illustrates, in the discrete-time domain (after computing an IDFT), the (amplitude value of the) correlation between a cyclically shifted base sequence and the corresponding non-shifted base sequence;

FIG. 6 illustrates correlation between cyclically shifted SRS base sequences, which have been transmitted over a frequency-selective channel, with the corresponding non-shifted base sequence;

FIG. 7 illustrates an example where layer 1 of a PDSCH is transmitted from TRP1 while layer 2 of the PDSCH is transmitted from TRP2;

FIG. 8 illustrates an example where a same PDSCH layer is transmitted over two TRPs;

FIG. 9 depicts a scenario in which UE 1 and UE 2 are transmitting SRS, which is received at both TRP 1 and TRP 2;

FIG. 10 illustrates UE 1 received at TRP 1 and TRP 2 for TRP-common SRS;

FIG. 11 illustrates UE 1 and UE 2 received at TRP 1 and TRP 2 for TRP-common SRS;

FIG. 12 illustrates a corresponding delay-domain channel estimates for the case when u₁=1 for UEs that are time aligned to TRP 1 (i.e., UE 1, in this example) and u₂=2 for UEs that are time aligned to TRP 2 (i.e., UE 2, in this example);

FIG. 13 illustrates the (normalized) delay-domain channel estimate at TRP t, for t=1, 2, where an SRS sequence with sequence group uₛ=1, 2, for s=1, 2 has been used in the matched filter;

FIG. 14 illustrates the (normalized) delay-domain channel estimate at TRP t, for t=1, 2, where an SRS sequence with sequence group uₛ=1, 2, for s=1, 2 has been used in the matched filter;

FIG. 15 illustrates a method performed by a network node for performing channel estimation;

FIG. 16 shows an example of a communication system in accordance with some embodiments;

FIG. 17 shows a UE in accordance with some embodiments;

FIG. 18 shows a network node in accordance with some embodiments;

FIG. 19 is a block diagram of a host, which may be an embodiment of the host of FIG. 16, in accordance with various aspects described herein;

FIG. 20 is a block diagram illustrating a virtualization environment in which functions implemented by some embodiments may be virtualized; and

FIG. 21 shows a communication diagram of a host communicating via a network node with a UE over a partially wireless connection in accordance with some embodiments.

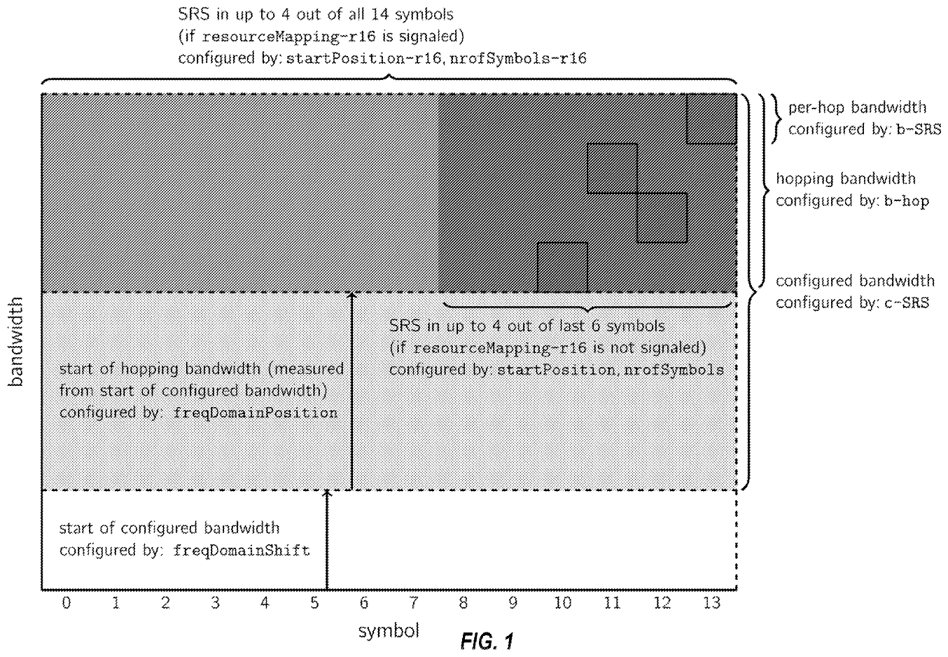

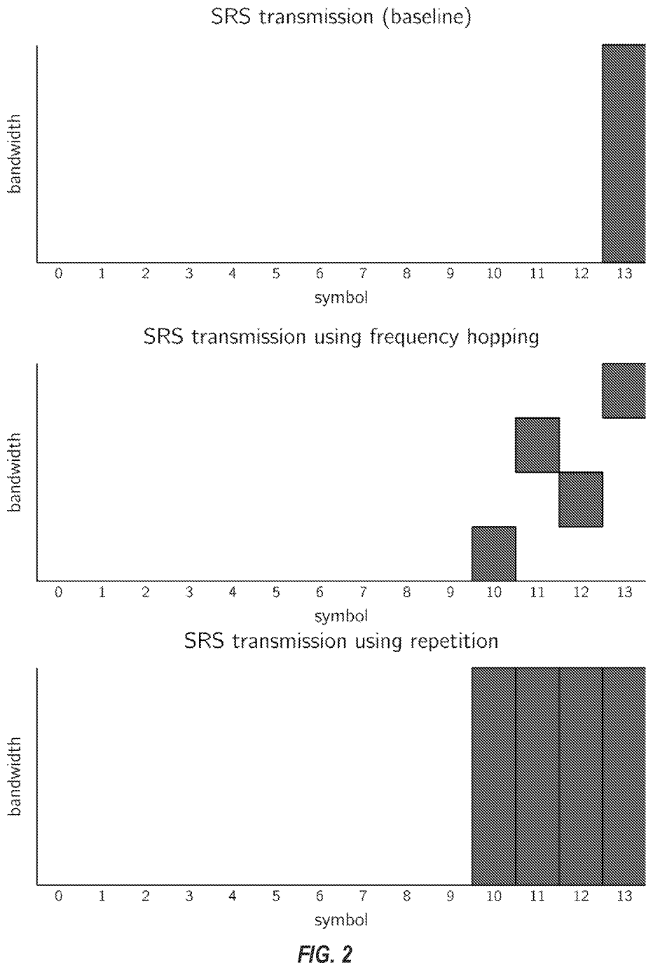

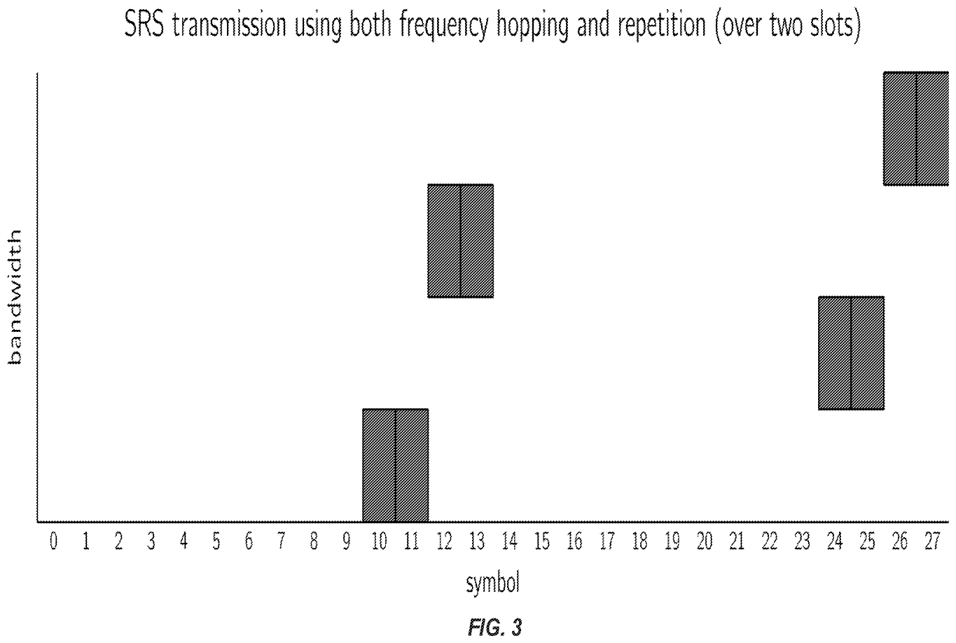

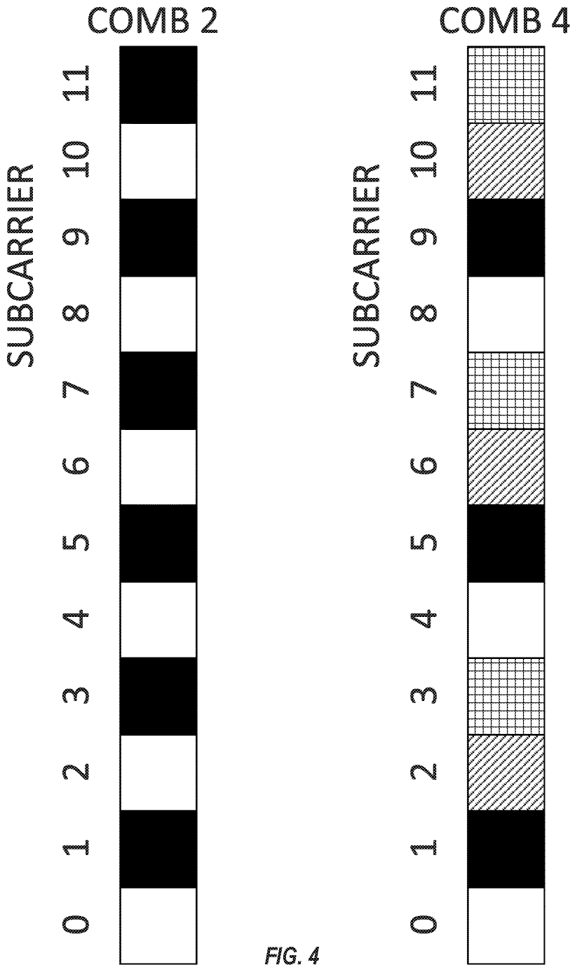

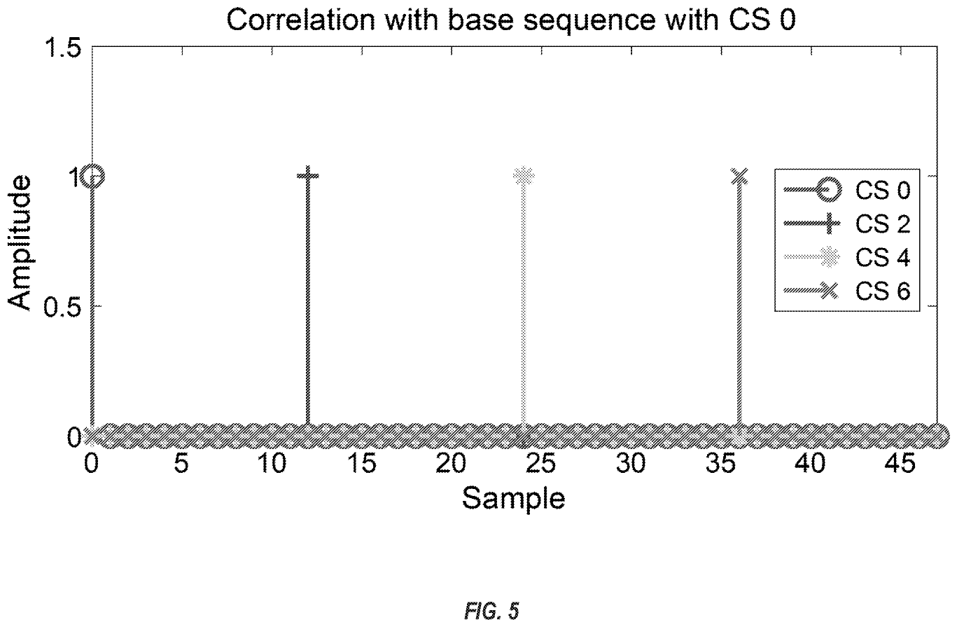

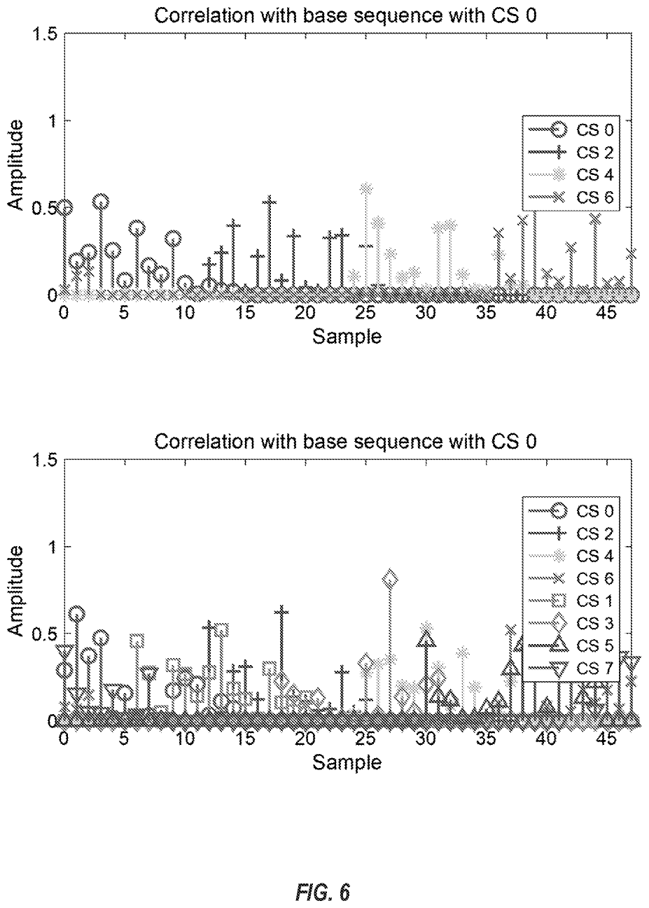

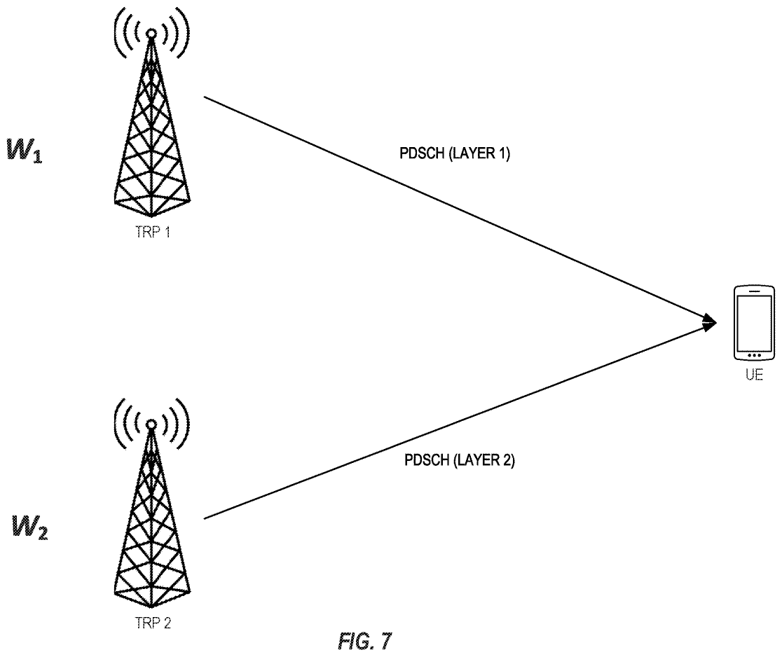

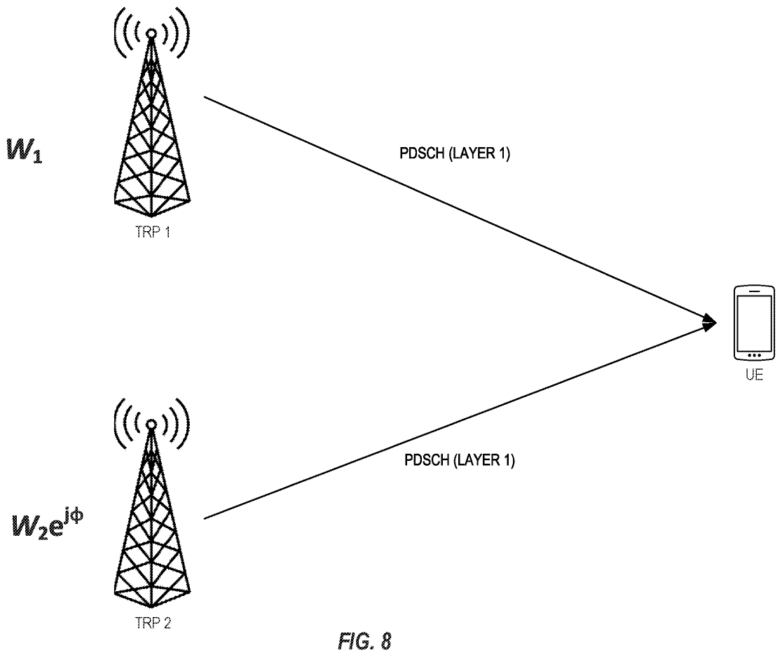

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenges. In case of reciprocity-based Downlink (DL) CJT from multiple TRPs, it is essential to attain SRS-based channel estimates from multiple different UEs at multiple different TRPs. However, if a same SRS resource is to be received at two TRPs, the difference propagation delay will result in additional interference for, at least, one of the two TRPs. Furthermore, the received power may vary significantly over the two TRPs resulting in additional interference for, at least, one of the two TRPs. In short, cross-SRS interference is a potential issue for Time Division Duplexing (TDD) CJT.

It is not clear, for the CJT use case, whether a same SRS sequence (TRP-common) will be used by UEs served by a set of TRPs or whether different SRS sequences (TRP-specific) will be used by different sets of UEs. In 3GPP, enhancements to both TRP-common and TRP-specific SRS are being suggested. Next, some of the issues with either of these approaches are discussed.

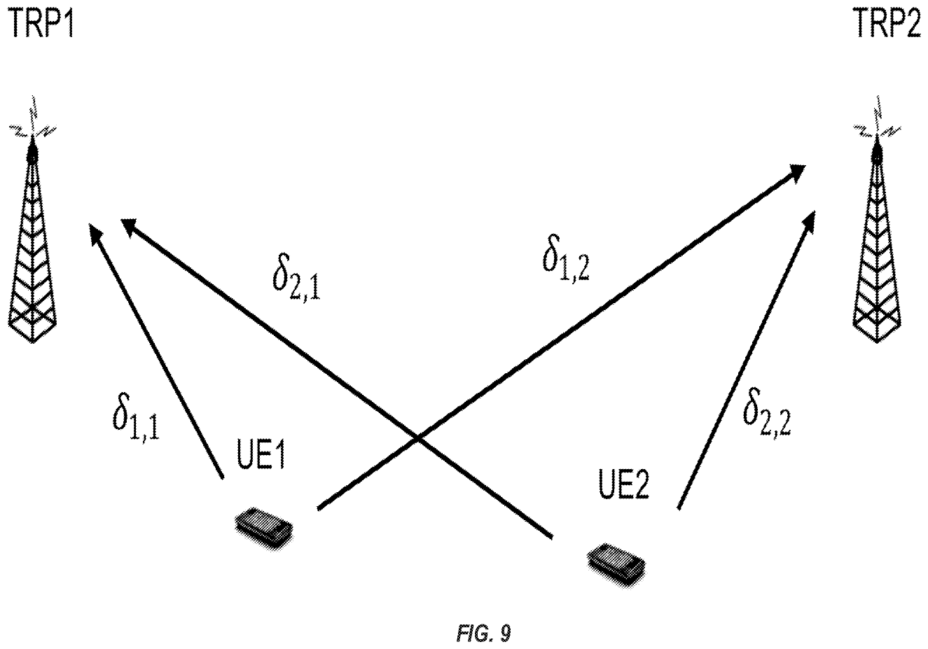

FIG. 9 depicts a scenario in which UE 1 and UE 2 are transmitting SRS, which is received at both TRP 1 and TRP 2. In the figure, δ_{x,y} is the propagation delay between UE x and TRP y. Here, UE x is time aligned to and power controlled by TRP x. In the following examples, the transmission comb is K_{TC}=4 (such that there are

$${n}_{SRS}^{CS , max} = 12 CSs$$

per comb offset) and the subcarrier spacing is f_{SCS}=60 kHz. For example, a wideband SRS transmission over 128 RBs (such that the sequence length is M_{ZC}=12/4·128=384 samples). The carrier frequency is 3.5 GHz. The channel between each UE port and TRP port is a random realization of the Tapped Delay Line (TDL)-A channel model with an (average) delay spread of 100 ns with free-space path loss (i.e., the path-loss coefficient is two) and propagation delay Δ_{x,y}=∂_{x,y}/c, where c is the speed of light. The noise level at the TRPs, for simplicity, is assumed to be negligible.

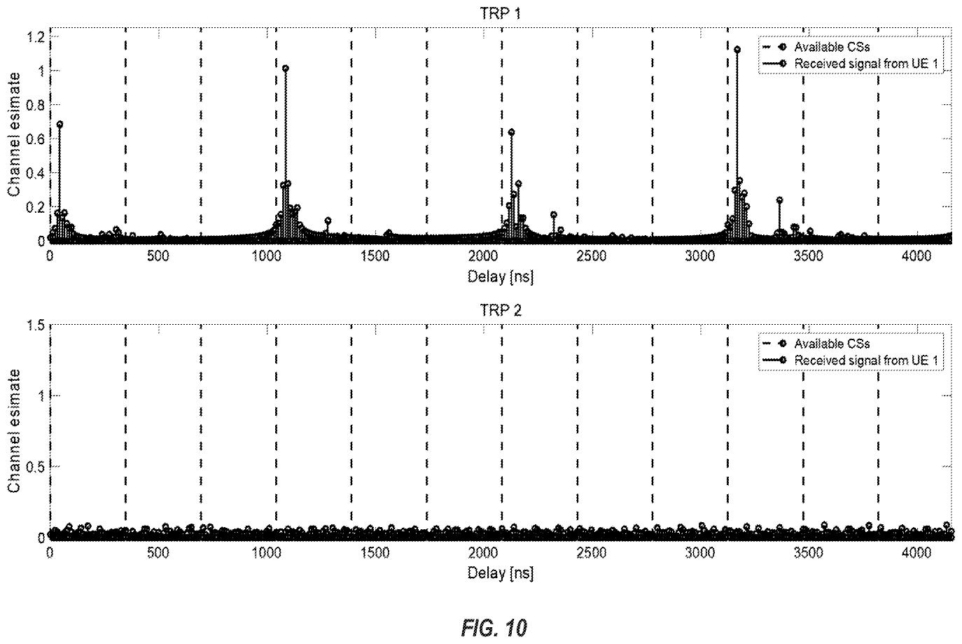

First, consider a 4-port SRS resource being transmitted from UE 1 (UE 2 is not transmitting) for the case δ_{1,1}=50 m and δ_{1,2}=150 m. In this case, the delay difference is Δ_{1,2}=(δ_{1,2}−δ_{1,1})/c≈333 ns. Recall that, in legacy NR, the separation between cyclic shifts is equidistant and that by configuring cyclicShift to m, for m=0, 1, . . . , 5, the 4 ports are mapped to CSs [0, 3, 6, 9]+m. For m=0, a realization of the received signals at an arbitrary antenna port at TRP 1 and TRP 2, respectively, are shown in FIG. 10. FIG. 10 illustrates UE 1 received at TRP 1 and TRP 2 for TRP-common SRS. Note that, at TRP 1, the SRS ports are received at the expected delays (i.e., at CS [0, 3, 6, 9]). At TRP 2, however, due to the difference in propagation delay, the SRS ports are shifted in the delay domain.

It can be shown that the separation between CSs is

$${Δ}_{CS} = ( {f}_{SCS} {K}_{TC} {n}_{SRS}^{CS , max} ) .$$

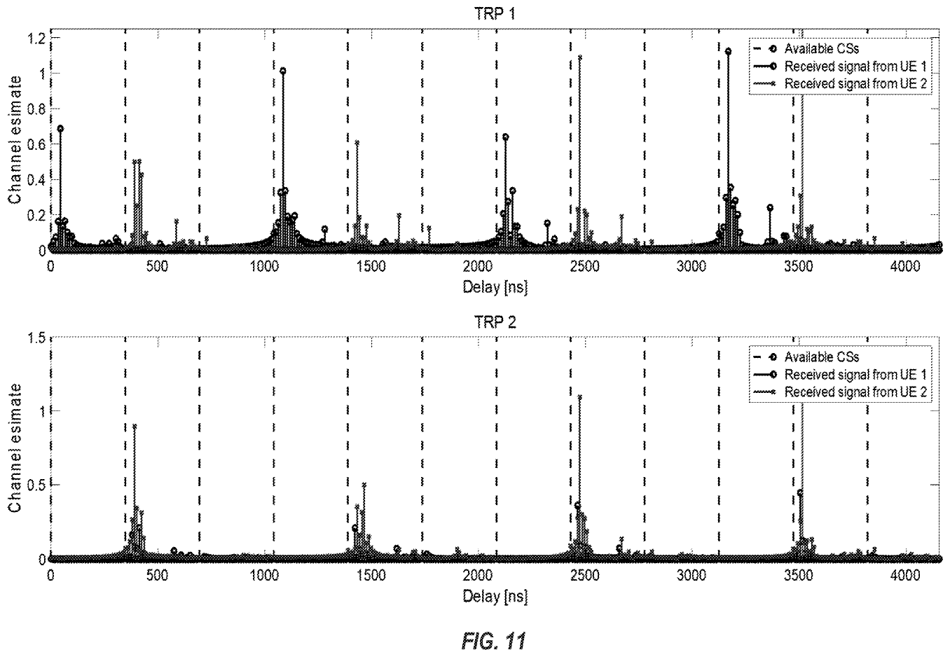

In this example, Δ_{CS}=347 ns and, hence, the delay shift due to propagation delay is in the same order as the separation between CSs which makes it challenging to schedule UEs using a same SRS sequence (TRP-common), especially if the propagation-delay difference is not known to the TRPs (which is typically assumed to be the case). Indeed, if TRP2 where to schedule a 4-port UE 2 (for which, in this example, for simplicity, δ_{2,1}=δ_{2,2}=100 m) with CSs [1,4,7,10], collisions would occur (see FIG. 11). FIG. 11 illustrates UE 1 and UE 2 received at TRP 1 and TRP 2 for TRP-common SRS. Here, contributions from different UEs, are shown using different markers. This problem becomes further aggravated when there is more than one UE per TRP, for which delay differences would be different for each UE. In short, delay differences in a CJT scenario reduces SRS capacity.

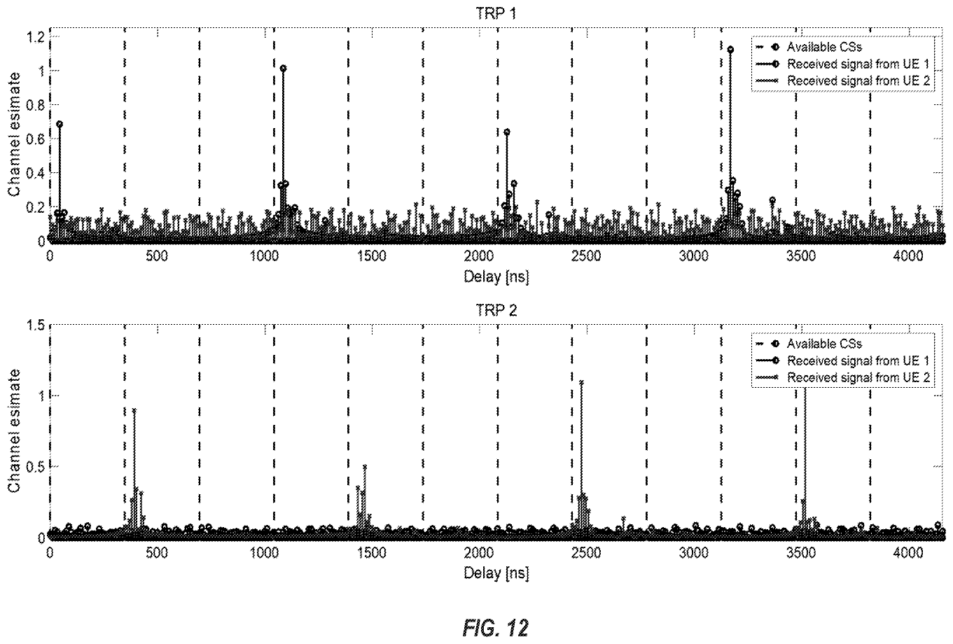

One way to circumvent this issue is to configure different SRS sequences for the two UEs (TRP-specific). In FIG. 12, the corresponding delay-domain channel estimates are shown for the case when u₁=1 for UEs that are time aligned to TRP 1 (i.e., UE 1, in this example) and u₂=2 for UEs that are time aligned to TRP 2 (i.e., UE 2, in this example). Here, TRP x use sequence u=uₓ when computing a frequency-domain least squares estimate of the received signal (i.e., in a matched filter). Note that, by using different SRS sequences, one avoids the issue of CSs colliding in the delay domain (compare FIG. 11 and FIG. 12). The downside of this approach, however, is that (since SRS sequences are, almost, uncorrelated) the received signal for UEs scheduled by another TRP will be approximately white in the delay domain, which increases interference and, hence, reduces the quality of the channel estimate, which, in turn, will decrease the DL throughput.

Certain aspects of the disclosure and their embodiments may provide solutions to these or other challenges. A method is proposed to support channel sounding over multiple TRPs to support reciprocity-based DL JT over the multiple TRPs by using a Successive Interference Cancellation (SIC) receiver when computing a channel estimate based on an UL-RS (e.g., SRS). The method can be summarized as follows:
A multi-TRP/D-MIMO deployment with T TRPs. Each TRP configures a same UL-RS sequence for all UEs served/time-aligned by said TRP.
The TRPs are aware of the UL-RS configuration for all UEs served by the T TRPs. I.e., the UL-RS configuration for all UEs served by TRP t=1, 2, . . . , T is known at TRP t′=1, 2, . . . , T, t′≠t.
For TRP t=1, 2, . . . , T, repeat for a number of iterations (which may be predetermined or until some stopping criteria is met) the following steps:
   The tth TRP estimates the channel for the UEs served by the tth TRP by using a matched filter which correlates the frequency domain received signal with the UL-RS sequence configured by the tth TRP followed by additional processing steps. Then subtract the frequency-domain estimated channel from the received signal.
   For t′=1, 2, . . . , T, t′≠t:
      The tth TRP estimates the channel for the UEs served by the t′th TRP by using a matched filter which correlates the frequency domain received signal with the UL-RS sequence configured by the t′th TRP. Then subtract the frequency-domain estimated channel from the received signal.

Note that examples in some embodiments of the present disclosure relate to two SRS resources, two sequences, and two TRPs. However, some embodiments herein can be extended to more than two SRS resources, more than two sequences, and more than two TRPs.

Certain embodiments may provide one or more of the following technical advantages. The proposed solution improves quality of reciprocity-based CSI in multi-TRP/D-MIMO deployments for which TRP-specific UL-RS sequences are configured.

A frequency-domain matched filter estimate of the channel between the sth UE and the tth TRP can be written as

$${\hat{h}}_{est}^{( sr )} ( k ) = {\hat{r}}_{{u}_{s} , 0}^{*} ( k ) {\hat{y}}^{( t )} ( k )$$

for k=0, 1, . . . , M_{ZC}−1. Here, ŷ^{(t)}(k) is the frequency-domain received signal at an arbitrary port at the tth TRP for the kth subcarrier carrying SRS. Note that ŷ^{(t)}(k) contains contributions from all SRS ports of all UEs that are simultaneously transmitting. Furthermore,

$${\hat{r}}_{{u}_{s} , 0}^{*} ( k )$$

is the conjugate of the SRS sequence (with sequence group uₛ) used at the sth UE. A corresponding delay-domain matched filter estimate

$${h}_{est}^{( s , t )} ( n )$$

for n=0, 1, . . . , M_{ZC}−1 can be obtained, e.g., by computing the IDFT of

$$\{ {\hat{h}}_{est}^{( sr )} ( k ) \}$$

(other transforms, such as Discrete Cosine Transform (DCT), can also be used). Typically, estimates of individual SRS ports are obtained by (adaptively) filtering/windowing the delay-domain channel estimates. In some embodiments, the channel estimate is typically of high quality if the individual ports can be easily distinguished/separated in the delay domain. In what follows,

$${\hat{h}}_{est}^{( s , t , p )} ( k ) and {h}_{est}^{( s , t , p )} ( n )$$

are used to denote the channel estimate for the pth SRS port for the channel between the sth UE and the tth TRP in the frequency-domain and delay-domain, respectively.

Some embodiments of the present disclosure can be further explained/understood via an example. For this reason, the same example as the TRP-specific SRS scenario presented above is considered, with the exception that the delay spread of the channel, for simplicity, is 0 ns (i.e., the channel is assumed to be frequency flat).

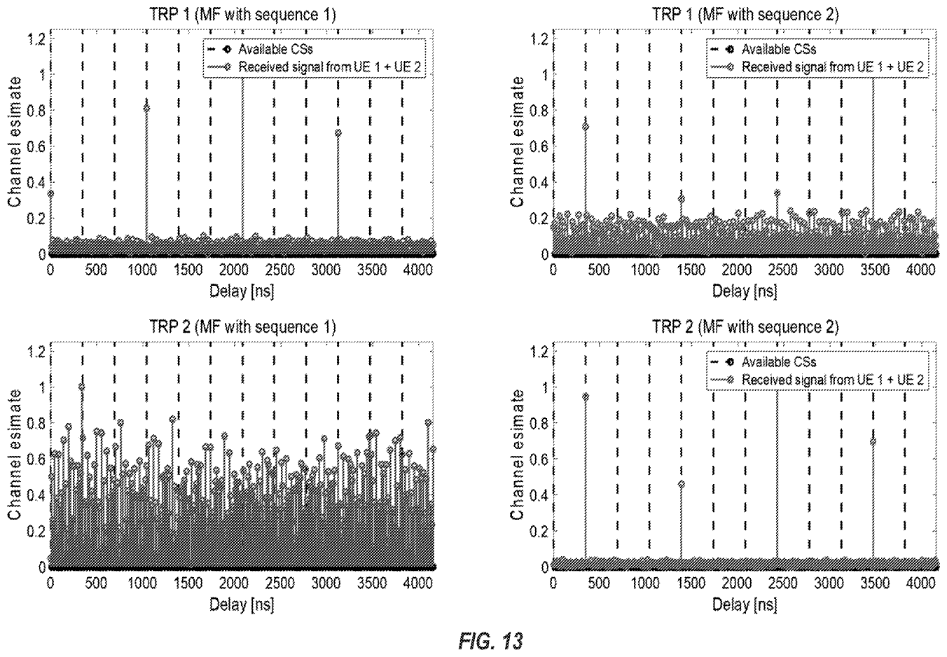

FIG. 13 illustrates the (normalized) delay-domain channel estimate at TRP t, for t=1, 2, where an SRS sequence with sequence group uₛ=1, 2, for s=1, 2 has been used in the matched filter. For example, FIG. 13 shows UE 1 and UE 2 received at TRP 1 and TRP 2, where each TRP uses matched filters based on both SRS sequences to estimate the channels for both UEs.

It can be observed that the four ports belonging to UE 1 (i.e., using sequence 1) can be accurately estimated at TRP 1 and that the four ports belonging to UE 2 (i.e., using sequence 2) can be accurately estimated at TRP 2. Unfortunately, the 4 ports belonging to UE 2 are severely affected by interference at TRP 1. Worse still, the 4 ports belonging to UE 1 are drowned completely in interference at TRP 2.

In a first step, at the tth TRP, the delay-domain channel estimate based on ŷ^{(t)}(k), for the receiver using the same sequence as UEs scheduled by the tth TRP, is windowed to obtain an estimate

$$\{ {h}_{est}^{( t , t , p )} ( n ) \}$$

for all the p=1, 2, . . . , 4 ports. In a second step,

$$\{ {\hat{h}}_{est}^{( t , t , p )} ( k ) \}$$

is obtained by converting the delay-domain estimates to frequency domain. In a third step, ŷ^{(t)}(k) is updated as follows:

$${\hat{y}}^{( t )} ( k ) ← {\hat{y}}^{( t )} ( k ) - {\sum }_{p = 1}^{4} {\hat{h}}_{est}^{( t , t , p )} ( k ) {\hat{r}}_{t , 0} ( k ) {e}^{j {α}_{p} k} ,$$

where αₚ is the cyclic shift assigned to the pth port. In a fourth step the delay-domain channel estimate based on the update ŷ^{(t)}(k), for the receiver using a different sequence than the UEs scheduled by the tth TRP, to obtain an estimate

$$\{ {h}_{est}^{( {t}^{′} , t , , p )} ( n ) \}$$

for all the p=1, 2, . . . , 4 ports belonging to the t′≠t TRP, to obtain an estimate UE.

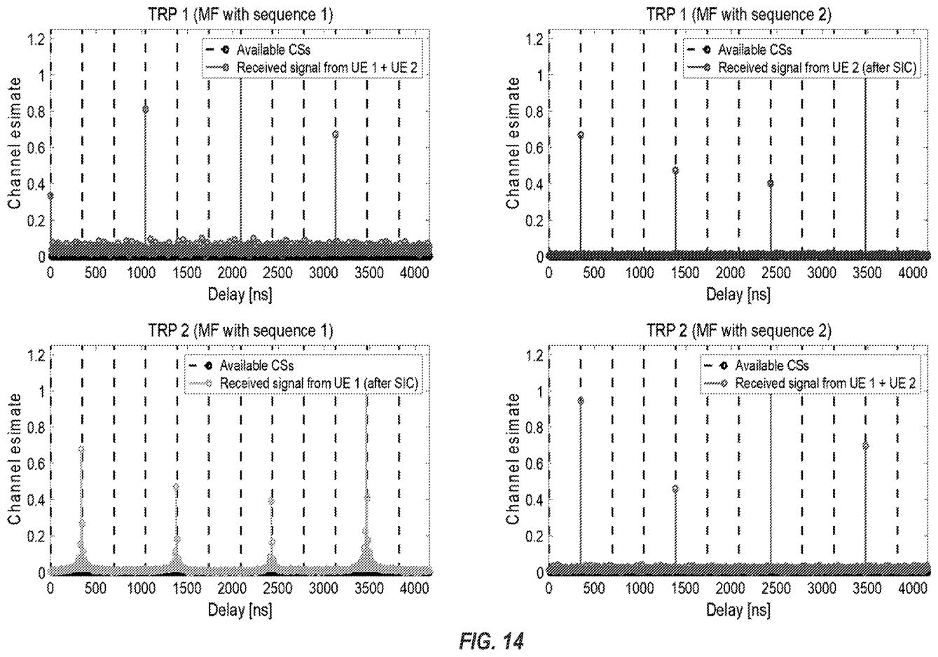

FIG. 14 illustrates the (normalized) delay-domain channel estimate at TRP t, for t=1, 2, where an SRS sequence with sequence group uₛ=1, 2, for s=1, 2 has been used in the matched filter. For example, FIG. 14 shows UE 1 and UE 2 received at TRP 1 and TRP 2, where each TRP uses matched filters based on both SRS sequences to estimate the channels for both UEs. When receiving a sequence different from the one configured by the TRP, SIC is used.

Here, the sequence-t′-based estimate, where t′≠t, has been obtained according to the SIC procedure detailed above. Comparing FIG. 13 and FIG. 14, SRS ports that are not scheduled by the receiving TRP can, after SIC, be accurately estimated, which demonstrates the advantage of the proposed method.

In further steps, it is possible to subtract from the received signal ports belonging to SRS resources configured by a different TRP (i.e., using a different sequence than UEs scheduled by the TRP) to improve the quality of the channel estimate for ports belonging to SRS resources configured by the receiving TRP.

In further steps, one can iterate the procedure above to further improve the quality of the channel estimate and subtract more inter-sequence interference.

In one embodiment, when estimating the channel for a UE served by the tth TRP, the UEs served by the other TRPs are ordered according to the received power of the UE at the tth TRP in descending order before applying the SIC receiver. The channels for the stronger UEs are then estimated and subtracted before the weaker UEs. In some embodiments, it is not the channel that is subtracted, it is the received signal contribution (which depends on the channel and RS sequence samples). The reason for this is that it is easier to estimate the channels for the strongest UEs first and that it is also beneficial to subtract the strongest interferers first to make it easier to estimate the channel for the weaker UEs. Ideally, all UEs served by the tth TRP, should have similar received power at the tth TRP due to the UL power control. When this is not the case, e.g., due to insufficient UE Tx power, the UEs served by the tth TRP could also be ordered according to strength before applying the SIC receiver.

In one embodiment, the received power at the TRP from the different UEs is estimated by correlating the frequency-domain received signal with the corresponding UE's SRS sequence (for all the UE's SRS ports) and summing the power over all subcarriers carrying SRS. In one further embodiment, the received powers are estimated iteratively by first subtracting previously estimated signals.

In one embodiment, the ordering of received power is based on the Peak-to-Average Power Ratio (PAPR) in delay domain, e.g., by performing an IDFT of the frequency-domain received signal after correlation with the UE's SRS sequence. A high PAPR in delay domain means that there is a good match between the received signal and the desired SRS sequence. In this case the peaks correspond to the desired sequence and the “noise” to the interference from other sequences. This can be useful when the delay is unknown.

In one embodiment, the received power at the TRP from the different UEs is estimated based on estimated power from previous measurements.

Note that some embodiments of the present disclosure can be used also for suppressing interference in CJT and/or non-CJT scenarios for the case when UL-RS configuration information are shared between a plurality of TRPs.

Some embodiments of the present disclosure could be used also for other UL-RSs (e.g., other than SRS).

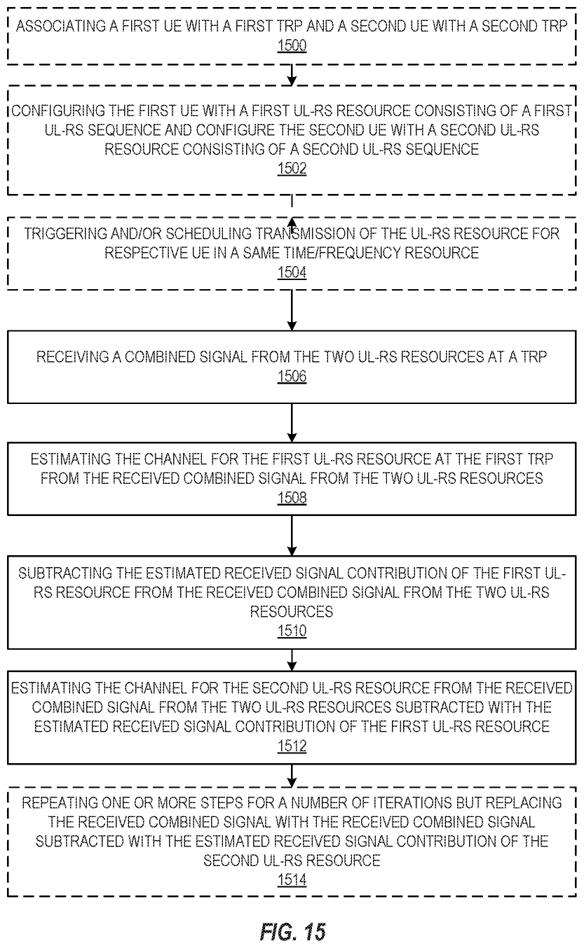

FIG. 15 illustrates a method performed by a network node for performing channel estimation. In some embodiments, this network node is a base station or a gNB. In some embodiments, this network node is one of the TRPs discussed in relation to this method. In some embodiments, the network node optionally associates (step 1500) a first UE with a first TRP and a second UE with a second TRP. The network node optionally configures (step 1502) the first UE with a first UL-RS resource comprising a first UL-RS sequence and configures the second UE with a second UL-RS resource comprising a second UL-RS sequence. The network node optionally triggers and/or schedules (step 1504) transmission of the UL-RS resource for respective UEs in a same time/frequency resource. In some embodiments, this is the first UL-RS for the first UE and the second UL-RS for the second UE. The network node receives (step 1506) a combined signal from the two UL-RS resources at a TRP. The network node estimates (step 1508) the channel for the first UL-RS resource at the first TRP from the received combined signal from the two UL-RS resources. The network node subtracts (step 1510) the estimated received signal contribution of the first UL-RS resource from the received combined signal from the two UL-RS resources. In some embodiments, this estimated received signal contribution is the channel estimated in step 1508. In some embodiments, the signal contribution is the product of two parts: the estimated channel from the previous step; and the corresponding RS sequence samples (which are known). The network node estimates (step 1512) the channel for the second UL-RS resource from the received combined signal from the two UL-RS resources subtracted with the estimated received signal contribution of the first UL-RS resource. In some embodiments, the network node optionally repeats (step 1514) one or more steps for a number of iterations but replacing the received combined signal with the received combined signal subtracted with the estimated received signal contribution of the second UL-RS resource.

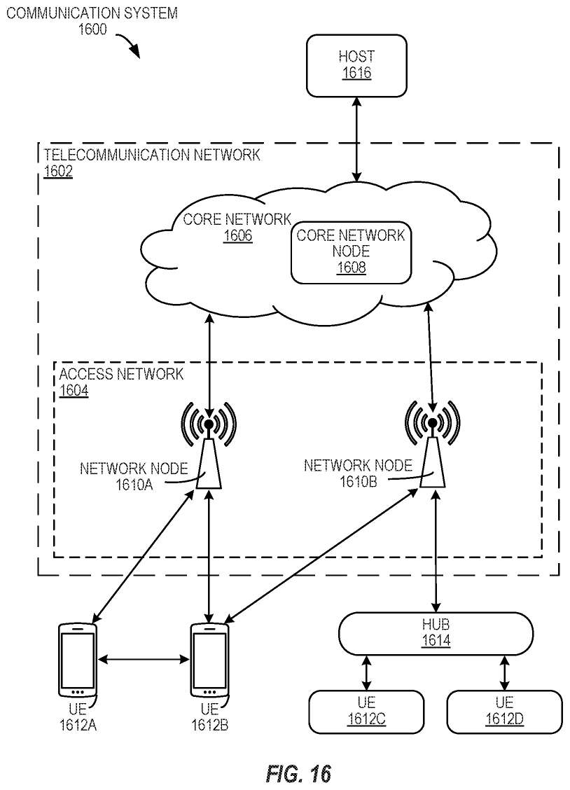

FIG. 16 shows an example of a communication system 1600 in accordance with some embodiments. In the example, the communication system 1600 includes a telecommunication network 1602 that includes an access network 1604, such as a Radio Access Network (RAN), and a core network 1606, which includes one or more core network nodes 1608. The access network 1604 includes one or more access network nodes, such as network nodes 1610A and 1610B (one or more of which may be generally referred to as network nodes 1610), or any other similar Third Generation Partnership Project (3GPP) access node or non-3GPP Access Point (AP). The network nodes 1610 facilitate direct or indirect connection of User Equipment (UE), such as by connecting UEs 1612A, 1612B, 1612C, and 1612D (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602 and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system 1600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1602 is a cellular network that implements 3GPP standardized features. Accordingly, the telecommunication network 1602 may support network slicing to provide different logical networks to different devices that are connected to the telecommunication network 1602. For example, the telecommunication network 1602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 1614 communicates with the access network 1604 to facilitate indirect communication between one or more UEs (e.g., UE 1612C and/or 1612D) and network nodes (e.g., network node 1610B). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a Virtual Reality (VR) headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610B. The hub 1614 may also allow for a different communication scheme and/or schedule between the hub 1614 and UEs (e.g., UE 1612C and/or 1612D), and between the hub 1614 and the core network 1606. In other examples, the hub 1614 is connected to the core network 1606 and/or one or more UEs via a wired connection. Moreover, the hub 1614 may be configured to connect to a Machine-to-Machine (M2M) service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610B. In other embodiments, the hub 1614 may be a non-dedicated hub—that is, a device which is capable of operating to route communications between the UEs and the network node 1610B, but which is additionally capable of operating as a communication start and/or end point for certain data channels.

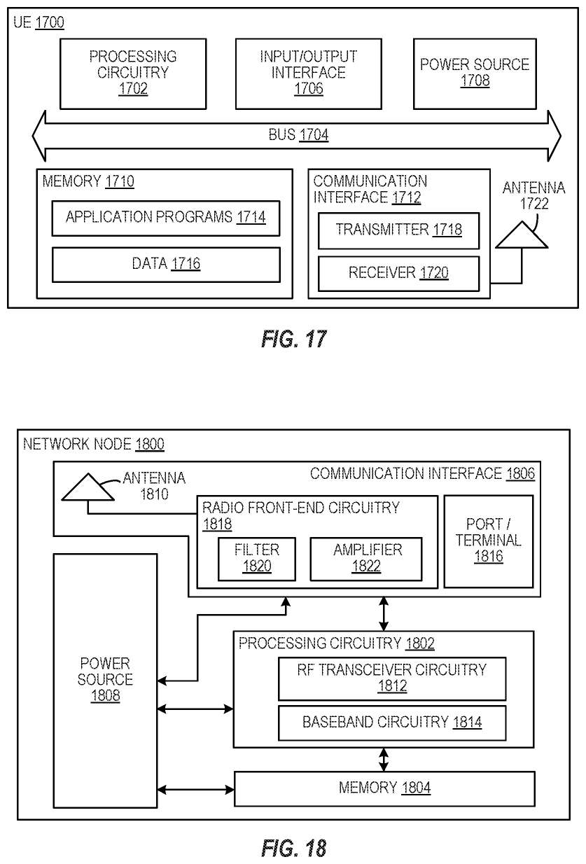

FIG. 17 shows a UE 1700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1702 may include multiple Central Processing Units (CPUs).

In the example, the input/output interface 1706 may be configured to provide an interface or interfaces to an input device, output device, or one or more input and/or output devices.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging the power source 1708. Power circuitry may perform any formatting, converting, or other modification to the power from the power source 1708 to make the power suitable for the respective components of the UE 1700 to which power is supplied.

The memory 1710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1710 may allow the UE 1700 to access instructions, application programs, and the like stored on transitory or non-transitory memory media, to off-load data, or to upload data. An article of manufacture, such as one utilizing a communication system, may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., the antenna 1722) and may share circuit components, software, or firmware, or alternatively be implemented separately.

In the illustrated embodiment, communication functions of the communication interface 1712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, and any kind of medical device, like a heart rate monitor or a remote controlled surgical robot, etc. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 18 shows a network node 1800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs (NBs), evolved NBs (eNBs), and NR NBs (gNBs)), and TRPs as described above, etc.

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes processing circuitry 1802, memory 1804, a communication interface 1806, and a power source 1808. The network node 1800 may be composed of multiple physically separate components (e.g., a NB component and an RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple Node Bs. In such a scenario, each unique NB and RNC pair may in some instances be considered a single separate network node. In some embodiments, the network node 1800 may be configured to support multiple RATs. In such embodiments, some components may be duplicated (e.g., separate memory 1804 for different RATs) and some components may be reused (e.g., an antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1800.

The processing circuitry 1802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1800 components, such as the memory 1804, to provide network node 1800 functionality. In some embodiments, the memory (1804) comprising instructions to cause the network node (1800) to perform the method described in relation to FIG. 15:

In some embodiments, the processing circuitry 1802 includes a System on a Chip (SOC). In some embodiments, the processing circuitry 1802 includes one or more of Radio Frequency (RF) transceiver circuitry 1812 and baseband processing circuitry 1814. In some embodiments, the RF transceiver circuitry 1812 and the baseband processing circuitry 1814 may be on separate chips (or sets of chips), boards, or units, such as radio units and digital units. In alternative embodiments, part or all of the RF transceiver circuitry 1812 and the baseband processing circuitry 1814 may be on the same chip or set of chips, boards, or units.

The memory 1804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and the memory 1804 are integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. The radio front-end circuitry 1818 comprises filters 1820 and amplifiers 1822. The radio front-end circuitry 1818 may be connected to the antenna 1810 and the processing circuitry 1802. The radio front-end circuitry 1818 may be configured to condition signals communicated between the antenna 1810 and the processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of the filters 1820 and/or the amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface 1806 may comprise different components and/or different combinations of components.

In certain alternative embodiments, the network node 1800 does not include separate radio front-end circuitry 1818; instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes the one or more ports or terminals 1816, the radio front-end circuitry 1818, and the RF transceiver circuitry 1812 as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, the communication interface 1806, and/or the processing circuitry 1802 may be configured to perform any receiving operations and/or certain obtaining operations described herein as being performed by the network node 1800. Any information, data, and/or signals may be received from a UE, another network node, and/or any other network equipment. Similarly, the antenna 1810, the communication interface 1806, and/or the processing circuitry 1802 may be configured to perform any transmitting operations described herein as being performed by the network node 1800. Any information, data, and/or signals may be transmitted to a UE, another network node, and/or any other network equipment.

The power source 1808 provides power to the various components of the network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid or an electricity outlet) via input circuitry or an interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

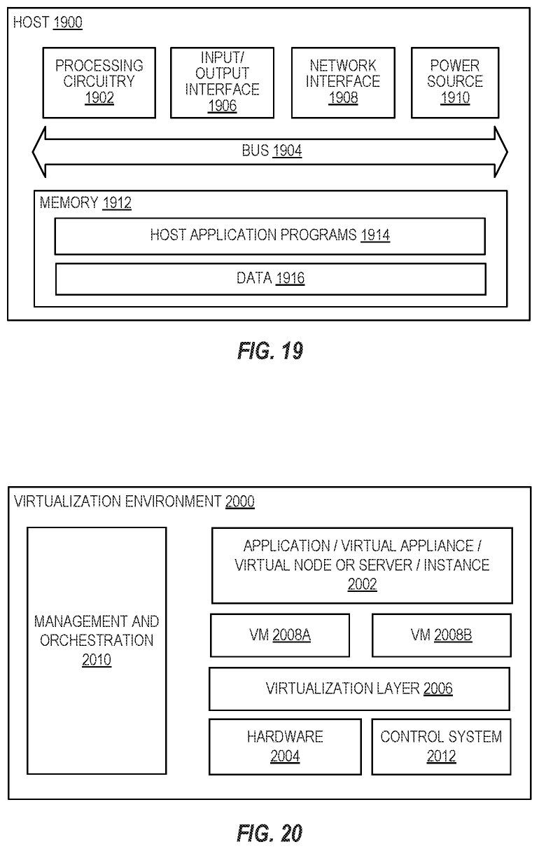

FIG. 19 is a block diagram of a host 1900, which may be an embodiment of the host 1616 of FIG. 16, in accordance with various aspects described herein. As used herein, the host 1900 may be or comprise various combinations of hardware and/or software including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and memory 1912. Other components may be included in other embodiments. Features of these components may be substantially similar to those described with respect to the devices of previous figures, such as FIGS. 17 and 18, such that the descriptions thereof are generally applicable to the corresponding components of the host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for Over-The-Top (OTT) services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment 1900 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or VM Monitors (VMMs)), provide VMs 2008A and 2008B (one or more of which may be generally referred to as VMs 2008), and/or perform any of the functions, features, and/or benefits described in relation with some embodiments described herein. The virtualization layer 2006 may present a virtual operating platform that appears like networking hardware to the VMs 2008.

The VMs 2008 comprise virtual processing, virtual memory, virtual networking, or interface and virtual storage, and may be run by a corresponding virtualization layer 2006. Different embodiments of the instance of a virtual appliance 2002 may be implemented on one or more of the VMs 2008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 2008 may be a software implementation of a physical machine that runs programs as if they were executing on a physical, non-virtualized machine. Each of the VMs 2008, and that part of the hardware 2004 that executes that VM, be it hardware dedicated to that VM and/or hardware shared by that VM with others of the VMs 2008, forms separate virtual network elements. Still in the context of NFV, a virtual network function is responsible for handling specific network functions that run in one or more VMs 2008 on top of the hardware 2004 and corresponds to the application 2002.

The hardware 2004 may be implemented in a standalone network node with generic or specific components. The hardware 2004 may implement some functions via virtualization. Alternatively, the hardware 2004 may be part of a larger cluster of hardware (e.g., such as in a data center or CPE) where many hardware nodes work together and are managed via management and orchestration 2010, which, among others, oversees lifecycle management of the applications 2002. In some embodiments, the hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 2012 which may alternatively be used for communication between hardware nodes and radio units.

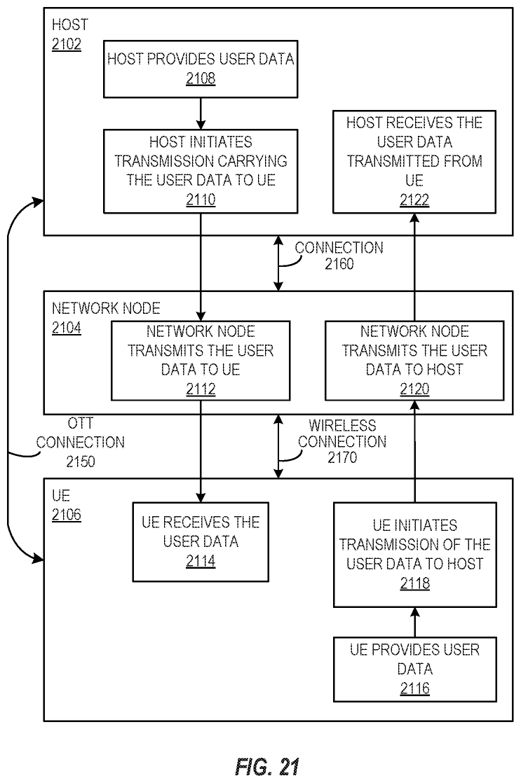

FIG. 21 shows a communication diagram of a host 2102 communicating via a network node 2104 with a UE 2106 over a partially wireless connection in accordance with some embodiments. Example implementations, in accordance with various embodiments, of the UE (such as the UE 1612A of FIG. 16 and/or the UE 1700 of FIG. 17), the network node (such as the network node 1610A of FIG. 16 and/or the network node 1800 of FIG. 18), and the host (such as the host 1616 of FIG. 16 and/or the host 1900 of FIG. 19) discussed in the preceding paragraphs will now be described with reference to FIG. 21.

Like the host 1900, embodiments of the host 2102 include hardware, such as a communication interface, processing circuitry, and memory. The host 2102 also includes software, which is stored in or is accessible by the host 2102 and executable by the processing circuitry. The software includes a host application that may be operable to provide a service to a remote user, such as the UE 2106 connecting via an OTT connection 2150 extending between the UE 2106 and the host 2102. In providing the service to the remote user, a host application may provide user data which is transmitted using the OTT connection 2150.

The network node 2104 includes hardware enabling it to communicate with the host 2102 and the UE 2106 via a connection 2160. The connection 2160 may be direct or pass through a core network (like the core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by the UE 2106 and executable by the UE's processing circuitry. The software includes a client application, such as a web browser or operator-specific “app” that may be operable to provide a service to a human or non-human user via the UE 2106 with the support of the host 2102. In the host 2102, an executing host application may communicate with the executing client application via the OTT connection 2150 terminating at the UE 2106 and the host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via the connection 2160 between the host 2102 and the network node 2104 and via a wireless connection 2170 between the network node 2104 and the UE 2106 to provide the connection between the host 2102 and the UE 2106. The connection 2160 and the wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104 in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

One or more of the various embodiments improve the performance of OTT services provided to the UE 2106 using the OTT connection 2150, in which the wireless connection 2170 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR, or AR which it can broadcast, multicast, or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 2150 between the host 2102 and the UE 2106 in response to variations in the measurement results. The measurement procedure and/or the network functionality for reconfiguring the OTT connection 2150 may be implemented in software and hardware of the host 2102 and/or the UE 2106. In some embodiments, sensors (not shown) may be deployed in or in association with other devices through which the OTT connection 2150 passes; the sensors may participate in the measurement procedure by supplying values of the monitored quantities exemplified above, or by supplying values of other physical quantities from which software may compute or estimate the monitored quantities. The reconfiguring of the OTT connection 2150 may include message format, retransmission settings, preferred routing, etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency, and the like by the host 2102. The measurements may be implemented in that software causes messages to be transmitted, in particular empty or ‘dummy’ messages, using the OTT connection 2150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

Those skilled in the art will recognize improvements and modifications to the embodiments of the present disclosure. All such improvements and modifications are considered within the scope of the concepts disclosed herein.

1. A method performed by a network node for performing channel estimation, the method comprising:
associating a first UE with a first Transmission and Reception Point, TRP, and a second UE with a second TRP;
receiving a combined signal from a first and second Uplink-Reference Signal, UL-RS, resource at the first TRP;
estimating a received signal contribution of the first UL-RS resource at the first TRP from the received combined signal from the two UL-RS resources;
subtracting the estimated received signal contribution of the first UL-RS resource from the received combined signal from the two UL-RS resources;
estimating a channel for the second UL-RS resource from the received combined signal from the two UL-RS resources subtracted with the estimated received signal contribution of the first UL-RS resource;
ordering UEs according to a received power at the first TRP;
performing the estimation and subtraction in order of decreasing received power; and
the received power at the first TRP being estimated by correlating a frequency-domain received signal with a corresponding UE's SRS sequence and summing the power over all subcarriers carrying an SRS to determine the received power from the different UEs.

2. The method of claim 1, further comprising:
repeating one or more steps for a number of iterations but replacing the received combined signal with the received combined signal subtracted with an estimated received signal contribution of the second UL-RS resource.

3. The method of claim 1, wherein the UL-RS comprises a Sounding Reference Signal, SRS.

4. (canceled)

5. The method of claim 1, further comprising:
configuring the first UE with a first UL-RS resource including a first UL-RS sequence and configuring the second UE with a second UL-RS resource including a second UL-RS sequence.

6. The method of claim 1, further comprising:
one or both triggering and scheduling transmission of a UL-RS resource for a respective UE in a same time/frequency resource.

7. The method of claim 1, wherein the first UE is time aligned with the first TRP and the second UE is time aligned with the second TRP.

8. The method of claim 1, wherein the first TRP and second TRP belong to a same cell.

9. The method of claim 1, wherein the first SRS resource associated with the first TRP is associated with a path loss reference signal transmitted from the first TRP and where the second SRS resource associated with the second TRP is associated with a path loss reference signal transmitted from the second TRP.

10. The method of claim 1, wherein the association between a UE and a TRP is based on lowest estimated path loss between the TRPs and the UEs, such that a UE is associated with a TRP that it has lowest path loss.

11. The method of claim 5, wherein the first SRS sequence and second SRS sequence are different from each other.

12. The method of claim 1, wherein the first TRP and second TRP belong to different cells.

13. (canceled)

14. (canceled)

15. The method of claim 1, wherein the received powers are estimated iteratively by first subtracting previously estimated signals.

16. The method of claim 1, wherein the ordering of received power is based on the Peak-to-Average Power Ratio, PAPR, in delay domain.

17. The method of claim 1, wherein the received power at the first TRP from the different UEs is estimated based on estimated power from previous measurements.

18. The method of claim 1, wherein when estimating the channel for a UE served by a tth TRP, UEs served by the other TRPs are ordered according to a received power of the UE at the tth TRP in descending order before applying a Successive Interference Cancellation, SIC, receiver.

19. The method of claim 18, wherein the received signal contribution for stronger UEs are then estimated and subtracted before weaker UEs.

20. (canceled)

21. (canceled)

22. The method of claim 1, wherein the steps are used for other UL-RSs.

23.-25. (canceled)

26. A network node comprising processing circuitry and memory, the memory comprising instructions to cause the network node to:
associate a first UE with a first Transmission and Reception Point, TRP, and a second UE with a second TRP;
receive combined signal from a first and second Uplink-Reference Signal, UL-RS, resources at the first TRP;
estimate a received signal contribution of the first UL-RS resource at the first TRP from the received combined signal from the two UL-RS resources;
subtract the estimated received signal contribution of the first UL-RS resource from the received combined signal from the two UL-RS resources;
estimate a channel for the second UL-RS resource from the received combined signal from the two UL-RS resources subtracted with the estimated received signal contribution of the first UL-RS resource;
order UEs according to a received power at the first TRP;
perform the estimation and subtraction in order of decreasing received power; and
cause the network node to estimate the received power at the first TRP by correlating a frequency-domain received signal with a corresponding UE's SRS sequence and summing the power over all subcarriers carrying an SRS to determine the received power from the different UEs.

27. The network node of claim 26, wherein the instructions further cause the network node to:
repeat one or more steps for a number of iterations but replacing the received combined signal with the received combined signal subtracted with an estimated received signal contribution of the second UL-RS resource.

28. A computer-readable storage medium storing instructions which, when executed on at least one processor, cause the at least one processor to perform a method for channel estimation, the method comprising:
associating a first UE with a first Transmission and Reception Point, TRP, and a second UE with a second TRP;
receiving a combined signal from a first and second Uplink-Reference Signal, UL-RS, resource at the first TRP;
estimating a received signal contribution of the first UL-RS resource at the first TRP from the received combined signal from the two UL-RS resources;
subtracting the estimated received signal contribution of the first UL-RS resource from the received combined signal from the two UL-RS resources;
estimating a channel for the second UL-RS resource from the received combined signal from the two UL-RS resources subtracted with the estimated received signal contribution of the first UL-RS resource;
ordering UEs according to a received power at the first TRP;
performing the estimation and subtraction in order of decreasing received power; and
the received power at the first TRP being estimated by correlating a frequency-domain received signal with a corresponding UE's SRS sequence and summing the power over all subcarriers carrying an SRS to determine the received power from the different UEs.
